(19) United States
(12) Patent Application Publication
(10) Pub. No.: US 2008/0079844 A1
(43) Pub. Date: Apr. 3, 2008

(54) Digital camera

(76) Inventors: Hideki Nagata, Hachioji-shi (JP); Minoru Omaki, Kunitachi-shi (JP)

Correspondence Address: KENYON & KENYON LLP, ONE BROADWAY, NEW YORK, NY, 10004, US

(21) Appl. No.: 11/901,827

(22) Filed: Sep. 18, 2007

(30) Foreign Application Priority Data
Sep. 25, 2006 (JP) 2006-258714

(51) Int. Cl. H04N 5/225

(52) U.S. Cl. 348/372

(57) ABSTRACT

Sinking when pressing a release button is reduced and hand shaking is suppressed, while maintaining compactness. A digital camera having a volume of 40 to 240 cc and a weight-to-volume ratio of 1.6 to 2.3 g/cc is provided. It has a weight-to-volume ratio sufficiently larger than the weight-to-volume ratio of a conventional standard compact digital camera, thus giving a photographer a greater sense of weight than its visual impression, which allows pictures to be taken while the arm muscles are tensed. Sinking of the digital camera due to pressing a release button can be reduced and hand-shaking suppressed.

### BACKGROUND OF THE INVENTION

1. Field of the Invention

The present invention relates to digital cameras.

This application is based on Japanese Patent Application No. 2006-258714, the content of which is incorporated herein by reference.

2. Description of Related Art

In large cameras in the related art, such as single-lens-reflex cameras, it is necessary to design a relatively high body weight in order to balance the heavy lens unit. In addition, photography using such a large camera is performed while tightly supporting the camera with both hands so as to hold a grip with the right hand and support the bottom of the lens unit with the left hand. By increasing the body weight, the camera is supported so as to sink into the photographer's hand, and a relatively large load is exerted on the photographer's arm, which causes the arm muscles to sufficiently tense. As a result, sinking of the body due to the photographer pressing the release button can be decreased, which allows pictures to be taken with reduced hand shaking.

On the other hand, as lenses have become comparatively smaller, such as in compact digital cameras, demands for portability have increased, and cameras are continuously becoming more compact and lightweight. (For example, see Japanese Unexamined Patent Application, Publication No. 2004-219789.)

### BRIEF SUMMARY OF THE INVENTION

A first aspect is a digital camera having a volume of 40 to 240 cc and weight-to-volume ratio of 1.6 to 2.3 g/cc.

A second aspect is the digital camera of the first aspect, wherein the weight-to-volume ratio is 1.8 to 2.1 g/cc.

A third aspect is a digital camera having a volume of 40 to 160 cc and a weight-to-volume ratio of 1.6 to 2.5 g/cc.

A fourth aspect is the digital camera according to the first aspect, comprising a camera body and a battery installed in the camera body, wherein the volume ratio of the battery relative to the battery and the camera body is 30 to 75%.

A fifth aspect is the digital camera according to the third aspect, comprising a camera body and a battery installed in the camera body, wherein the volume ratio of the battery relative to the battery and the camera body is 30 to 75%.

A sixth aspect is the digital camera according to the first aspect, comprising a camera body and a battery installed in the camera body, wherein the weight ratio of the battery relative to the battery and the camera body is 56 to 90%.

A seventh aspect is the digital camera according to the third aspect, comprising a camera body and a battery installed in the camera body, wherein the weight ratio of the battery relative to the battery and the camera body is 56 to 90%.

An eighth aspect is the digital camera according to the first aspect, wherein the total weight is 500 g or less.

A ninth aspect is the digital camera according to the third aspect, wherein the total weight is 500 g or less.

### DETAILED DESCRIPTION OF THE INVENTION

A digital camera of the present invention has a volume of 40 to 240 cc and weight-to-volume ratio of 1.6 to 2.3 g/cc.

In the embodiment described above, the weight-to-volume ratio is preferably 1.8 to 2.1 g/cc.

Another digital camera of the present invention has a volume of 40 to 160 cc and a weight-to-volume ratio of 1.6 to 2.5 g/cc.

Because these digital cameras have a weight-to-volume ratio that is sufficiently larger than the weight-to-volume ratio of a conventional standard compact digital camera, it is possible to produce some disparity between the impression that the photographer gets visually and the sense of weight experienced when actually holding the digital camera in his or her hand. As a result, while maintaining compactness, it is possible for the photographer to take pictures with his or her arm muscles tensed, and sinking of the digital camera due to pressing the release button can be reduced, thus suppressing hand shaking.

The digital camera described above may include a camera body and a battery installed in the camera body, wherein the volume ratio of the battery relative to the battery and the camera body may be 30 to 75%.

The digital camera described above may include a camera body and a battery installed in the camera body, wherein the weight ratio of the battery relative to the battery and the camera body may be 56 to 90%.

Accordingly, it is possible to increase the weight by occupying the space inside the camera body with the battery, while keeping the volume of the camera body small. Thus, it is possible to suppress hand shaking, while at the same time allowing picture taking or playback to be performed over a long period of time.

In the digital camera described above, the total weight is preferably 500 g or less.

Accordingly, muscle fatigue can be lessened and hand-shaking can be reduced even when taking pictures over a long period of time.

The digital camera described above affords an advantage in that, while maintaining compactness, sinking when pressing the shutter release button can be reduced, and hand-shaking can be suppressed.

The digital camera will be described below.

The digital camera includes a camera body and a battery installed inside the camera body.

The digital camera body includes a lens unit for forming an image of a subject, an image-acquisition device for converting the image of the subject formed by the lens unit into electrical image data, an image processing unit for subjecting the image data acquired by the image-acquisition device to predetermined image processing, a monitor, such as a liquid crystal display, for displaying the processed image data, and a memory for storing the image data.

The battery may be one that can be charged by external power while installed inside the camera body, or it may be one that can be removed from the camera body and charged externally.

The digital camera is a so-called compact digital camera having a total volume of 40 to 240 cc and a weight-to-volume ratio which is set to 1.6 to 2.3 g/cc. The weight-to-volume ratio is preferably 1.8 to 2.1 g/cc.

Therefore, in an ultracompact digital camera with a total volume of 40 cc, the total weight is 64 g to 92 g, preferably, 72 g to 84 g. In the case of a comparatively large compact digital camera with a total volume of 240 cc, the total weight is 384 g to 552 g, preferably 432 g to 504 g.

The digital camera has the total volume and total weight described above, and the volume that the battery occupies of that total volume is set to 30 to 75%. Also, the weight that the battery occupies of the total weight is set to 56 to 90%.

Such a digital camera has a weight-to-volume ratio that is sufficiently larger than the weight-to-volume ratio of a conventional standard compact digital camera; therefore, it is possible to produce some disparity between the impression that the photographer gets visually and the sense of weight experienced when he or she actually holds the digital camera in his or her hand.

In other words, when the photographer holds the digital camera, it is possible to make it feel heavier than the impression obtained by looking at it, and the photographer's arm muscles can thus be moderately tensed.

As a result, photography can be performed with such a digital camera while it is supported tightly by moderately tensed arms, which affords an advantage in that it is possible to suppress sinking of the camera body even when the release button is pressed, thus allowing a blur-free image to be acquired.

Moreover, with such a digital camera, the ratio occupied by the battery is increased so that the weight-to-volume ratio is made larger than that of a conventional camera. Therefore, the battery capacity can be increased, and as a result, it is possible to take pictures and play them back over a long period of time.

Here, a verification experiment using the compact digital camera and multiple types of metal plates will be described.

As shown in Table 1, ten shots were taken by each of ten photographers using two kinds of conventional compact digital cameras A and B and mockup digital cameras A1 to A4 and B1 to B4 to which multiple types of metal plates were attached.

TABLE 1

| | | | | | | | | Overall | | |
|---|---|---|---|---|---|---|---|---|---|---|
| | Camera dimensions | | | Weight | | Metal plates | | Total | Total | |
| | Width | Height | Depth | Camera | Battery | Weight | Volume | weight | Volume | Ratio |
| A | 99 | 53 | 22 | 112 | 15 | 0 | 0 | 127.0 | 115.4 | 1.1 |
| A1 | 99 | 53 | 22 | 112 | 15 | 28.3 | 3.6 | 155.3 | 119.0 | 1.3 |
| A2 | 99 | 53 | 22 | 112 | 15 | 70.7 | 9.0 | 197.7 | 124.4 | 1.6 |
| A3 | 99 | 53 | 22 | 112 | 15 | 141.5 | 18.0 | 268.5 | 133.4 | 2.0 |
| A4 | 99 | 53 | 22 | 112 | 15 | 240.5 | 30.6 | 367.5 | 146.0 | 2.5 |
| B | 103 | 57.5 | 33 | 181.5 | 30 | 0 | 0 | 211.5 | 195.4 | 1.1 |
| B1 | 103 | 57.5 | 33 | 181.5 | 30 | 56.6 | 7.2 | 268.1 | 202.6 | 1.3 |
| B2 | 103 | 57.5 | 33 | 181.5 | 30 | 127.3 | 16.2 | 338.8 | 211.6 | 1.6 |
| B3 | 103 | 57.5 | 33 | 181.5 | 30 | 240.5 | 30.6 | 452.0 | 226.0 | 2.0 |
| B4 | 103 | 57.5 | 33 | 181.5 | 30 | 353.7 | 45.0 | 565.2 | 240.4 | 2.4 |

The photographic conditions were as follows: party venue, no flash, lens angle of view 35 mm for 50 mm film, and shutter speed 1/30 second. The number of shots considered to have hand shaking, for a total of 1000 shots taken under these photographic conditions, was counted; this is shown in Table 2.

TABLE 2

| | Ratio | Hand shaking | Evaluation |
|---|---|---|---|
| A | 1.1 | 42 | Poor |
| A1 | 1.3 | 34 | Poor |
| A2 | 1.6 | 12 | Good |
| A3 | 2.0 | 8 | Good |
| A4 | 2.5 | 18 | Good |
| B | 1.1 | 38 | Poor |
| B1 | 1.3 | 28 | Poor |
| B2 | 1.6 | 17 | Good |
| B3 | 2.0 | 14 | Good |
| B4 | 2.4 | 30 | Poor |

According to Table 2, in the case of the digital cameras A with a volume of 40 to 160 cc, better hand-shaking reduction was observed when the weight-to-volume ratio (Ratio) was 1.6 to 2.5; in the case of the digital cameras B with a volume of 160 to 240 cc, a better hand-shaking suppression effect was observed when the weight-to-volume ratio was 1.6 to 2.0. Overall, in a digital camera with a volume of 40 to 240 cc, it is considered possible to obtain a good hand-shaking suppression effect if the weight-to-volume ratio is about 1.6 to 2.1.

Then, in digital cameras with volumes of 40 to 240 cc, batteries satisfying the above-described conditions were investigated; this is shown in Table 3. Cases where the battery ratio was 2.5 g/cc and 3.0 g/cc are both shown in Table 3.

TABLE 3

| | | | | | |
|---|---|---|---|---|---|
| Total ratio | 1.6 | Total volume | 40.0 | 240.0 | |
| Camera body ratio | 1.0 | Total weight | 64.0 | 384.0 | |
| Battery ratio | 2.5 | Camera volume | 24.0 | 144.0 | |
| | | Battery volume | 16.0 | 96.0 | |
| | | Battery weight | 40.0 | 240.0 | |
| | | Volume ratio | 40.0 | 40.0 | |
| | | Weight ratio | 62.5 | 62.5 | |
| Total ratio | 2.1 | Total volume | 40.0 | 240.0 | |
| Camera body ratio | 1.0 | Total weight | 84.0 | 504.0 | |
| Battery ratio | 2.5 | Camera volume | 10.7 | 64.0 | |
| | | Battery volume | 29.3 | 176.0 | |
| | | Battery weight | 73.3 | 440.0 | |
| | | Volume ratio | 73.3 | 73.3 | |
| | | Weight ratio | 87.3 | 87.3 | |
| Total ratio | 1.6 | Total volume | 40.0 | 240.0 | |
| Camera body ratio | 1.0 | Total weight | 64.0 | 384.0 | |
| Battery ratio | 3.0 | Camera volume | 28.0 | 168.0 | |
| | | Battery volume | 12.0 | 72.0 | |
| | | Battery weight | 36.0 | 216.0 | |
| | | Volume ratio | 30.0 | 30.0 | Good |
| | | Weight ratio | 56.3 | 56.3 | Good |
| Total ratio | 2.5 | Total volume | 40.0 | 240.0 | |
| Camera body ratio | 1.0 | Total weight | 100.0 | 600.0 | |
| Battery ratio | 3.0 | Camera volume | 10.0 | 60.0 | |
| | | Battery volume | 30.0 | 180.0 | |
| | | Battery weight | 90.0 | 540.0 | |
| | | Volume ratio | 75.0 | 75.0 | Good |
| | | Weight ratio | 90.0 | 90.0 | Good |

According to this, regarding the volume ratio and the weight ratio, which show the ratio of the volume or weight of the battery relative to the volume or weight of the overall digital camera, including the battery, it is considered possible to obtain a good hand-shaking suppression effect when the volume ratio is 30 to 75% and the weight ratio is 56 to 90%.

In Table 1 and Table 2, regardless of the fact that the digital camera B4 has a high total weight, the low hand-shaking suppression effect is considered to be due to the hand becoming tired after taking pictures for a long period of time. Therefore, it is preferable that the digital camera have a total weight of 500 g or less.

What is claimed is:

1. A digital camera having a volume of 40 to 240 cc and a weight-to-volume ratio of 1.6 to 2.3 g/cc.

2. A digital camera according to claim 1, wherein the weight-to-volume ratio is 1.8 to 2.1 g/cc.

3. A digital camera having a volume of 40 to 160 cc and a weight-to-volume ratio of 1.6 to 2.5 g/cc.

4. A digital camera according to claim 1, comprising a camera body and a battery installed in the camera body,
wherein the volume ratio of the battery relative to the battery and the camera body is 30 to 75%.

5. A digital camera according to claim 3, comprising a camera body and a battery installed in the camera body,
wherein the volume ratio of the battery relative to the battery and the camera body is 30 to 75%.

6. A digital camera according to claim 1, comprising a camera body and a battery installed in the camera body,
wherein the weight ratio of the battery relative to the battery and the camera body is 56 to 90%.

7. A digital camera according to claim 3, comprising a camera body and a battery installed in the camera body,
wherein the weight ratio of the battery relative to the battery and the camera body is 56 to 90%.

8. A digital camera according to claim 1, wherein the total weight is 500 g or less.

9. A digital camera according to claim 3, wherein the total weight is 500 g or less.
